(19) United States
(12) Patent Application Publication
(10) Pub. No.: US 2024/0079161 A1
(43) Pub. Date: Mar. 7, 2024

(54) TWO-CORE TWISTED SHIELDED CABLE AND WIRE HARNESS

(71) Applicant: YAZAKI CORPORATION, Tokyo (JP)

(72) Inventors: Yutaka Handa, Susono-shi (JP); Shuichi Inoue, Susono-shi (JP)

(21) Appl. No.: 18/452,509

(22) Filed: Aug. 18, 2023

(30) Foreign Application Priority Data
Sep. 6, 2022 (JP) 2022-141376

(51) Int. Cl. H01B 11/10; H01B 7/00; H01B 7/30; H01B 11/18

(52) U.S. Cl. CPC H01B 11/1041; H01B 7/0045; H01B 7/303; H01B 11/1813; H01B 11/1033

(57) ABSTRACT

A two-core twisted shielded cable includes two insulated wires being twisted together, a metal foil shield, a metal braid, and a sheath. A relationship between an ellipse circumscribing the two insulated wires and a width of the metal foil shield is the width=an elliptical circumference/(1−α), and 0.20≤α≤0.40. The metal foil shield has a thickness of 15 μm or more and 120 μm or less, includes a metal layer and a PET film layer, and 0.10≤(a metal layer thickness/a PET film layer thickness)≤1.25.

### CROSS-REFERENCE TO RELATED APPLICATIONS

This application is based on and claims priority under 35 USC 119 from Japanese Patent Application No. 2022-141376 filed on Sep. 6, 2022, the entire content of which is incorporated herein by reference.

### TECHNICAL FIELD

The present invention relates to a two-core twisted shielded cable and a wire harness.

### BACKGROUND ART

In the related art, there has been proposed a two-core shielded cable for high-speed digital signal transmission for the purpose of improving characteristics of a leakage attenuation amount when a differential signal is applied. The two-core shielded cable includes two electric wires, a metal foil shield provided around the two electric wires, a metal braid on the metal foil shield, and a sheath provided on the metal braid. Such a two-core shielded cable has a high frequency of a signal to be transmitted, and it is effective to have a metal foil shield having a smooth surface in consideration of a skin effect and a return current.

Here, a multi-core (three or more cores) shielded cable has been proposed (for example, see Patent Literatures 1 to 3). In a shielded cable described in Patent Literature 1, a pair of electric wires are shielded by a metal foil shield, and the shielded pair of electric wires are arranged in a circular shape.

A shielded cable described in Patent Literature 2 has a quad configuration in which four insulated wires (four core wires) are twisted at one time, and has a configuration in which a metal foil shield is provided around the four core wires, a two-core shielded cable is provided on an outer periphery of the metal foil shield, and a sheath is further provided on an outer periphery of the two-core shielded cable.

A shielded cable described in Patent Literature 3 has a configuration in which three insulated wires (three core wires) are twisted at one time, a tubular member having magnetic powder is laterally wound (spirally wound) around the three core wires, and a sheath is provided on an outer periphery thereof.

The following shielded cables have been proposed as two-core or single-core shielded cables (see Patent Literatures 4 and 5). A shielded cable described in Patent Literature 4 is configured such that a metal foil shield is laterally wound (spirally wound) around two insulated wires (two core wires) arranged in parallel, and a resin tape is provided on an outer periphery thereof.

A shielded cable described in Patent Literature 5 is configured such that a metal foil shield is longitudinally attached around insulated wires arranged in parallel, a two-core shielded cable is provided on an outer periphery thereof, and a sheath is further provided on an outer periphery thereof.

### CITATION LIST

### Patent Literature

Patent Literature 1: JP2015-72774A
Patent Literature 2: JP2003-132743A
Patent Literature 3: JP2015-153497A
Patent Literature 4: JP2015-185527A
Patent Literature 5: JP2007-265797A

### SUMMARY OF INVENTION

Here, it is preferable that the shielded cable can be manufactured at low cost and the metal foil shield is easily trimmed at the time of terminal processing. For this reason, it is preferable that the metal foil shield is longitudinally attached to the two insulated wires on an inner side rather than spirally wound. In a case of the spiral winding, it takes a long time to wind the metal foil shield around the two insulated wires, which makes it difficult to manufacture the shielded cable at low cost. Further, this is because, in the case of the spiral winding, it is difficult to trim a lower portion of the overlapped metal foil shield in a lap portion of the spirally wound metal foil shield. Therefore, in consideration of the manufacturing cost and a trimming property, it can be said that the metal foil shield is preferably longitudinally attached.

However, when the metal foil shield is longitudinally attached to two insulated wires, it is likely to be difficult to provide the metal foil shield along the two insulated wires, that is, in close contact with the two insulated wires. Therefore, a position of the metal foil shield with respect to the insulated wire becomes unstable, and the transmission characteristics are likely to deteriorate.

The present invention has been made to solve such a problem of the related art, and an object of the present invention is to provide a two-core twisted shielded cable and a wire harness which are inexpensive, can be easily trimmed, and can prevent deterioration of transmission characteristics.

A two-core twisted shielded cable according to the present invention includes two insulated wires twisted together and each having a conductor and an insulator covering the conductor, a metal foil shield provided longitudinally around the two insulated wires, a metal braid provided on an outer periphery of the metal foil shield, and a sheath provided on an outer periphery of the metal braid. A width of the metal foil shield satisfy a following relationship: the width=an elliptical circumference/(1−α), and 0.20≤α≤0.40. The elliptical circumference is a circumference length of an ellipse circumscribing the two insulated wires twisted together in a cross section orthogonal to a longitudinal direction. A first direction in which the two insulated wires are arranged is defined as a major axis, and a second direction orthogonal to the major axis is defined as a minor axis. The major axis is the sum of outer diameters of the two insulated wires, and the minor axis is 1.64 times the average outer diameter of the two insulated wires. The ellipse has the major axis and the minor axis. The metal foil shield has a thickness of 15 μm or more and 120 μm or less, includes a metal layer and a PET film layer, and 0.10≤(a metal layer thickness/a PET film layer thickness)≤1.25.

According to the present invention, it is possible to provide the two-core twisted shielded cable and the wire harness which are inexpensive, can be easily trimmed, and can prevent the deterioration of the transmission characteristics.

### BRIEF DESCRIPTION OF DRAWINGS

FIG. 1 is a perspective view of a wire harness including a two-core twisted shielded cable according to an embodiment of the present invention;

FIG. 2 is a perspective view showing the two-core twisted shielded cable shown in FIG. 1;

FIG. 3 is a cross-sectional view showing the two-core twisted shielded cable shown in FIG. 1;

FIG. 4 is an end view showing a two-core twisted shielded cable in Reference Example 1;

FIG. 5 is an end view showing a two-core twisted shielded cable in Reference Example 2;

FIG. 6 is a graph showing communication characteristics when a value of α of a width=an elliptical circumference/(1−α) is changed; and

FIG. 7 is a graph showing communication characteristics when a value of a metal layer thickness/a PET film layer thickness is changed.

### DESCRIPTION OF EMBODIMENTS

Hereinafter, the present invention will be described with reference to preferred embodiments. It should be noted that the present invention is not limited to the following embodiments, and can be appropriately modified without departing from the scope of the present invention. In addition, in the embodiments described below, although there are portions in which illustration and description of a part of the configuration are omitted, it is needless to say that a known or well-known technique is appropriately applied to the details of the omitted technique within a range in which no contradiction with the contents described below occurs.

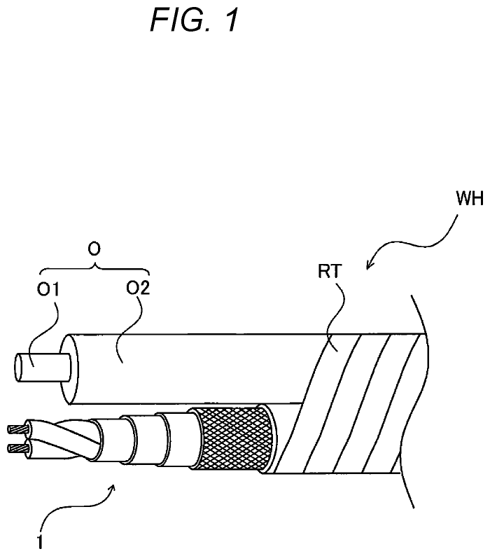

FIG. 1 is a perspective view of a wire harness including a two-core twisted shielded cable according to an embodiment of the present invention. As shown in FIG. 1, a wire harness WH includes a two-core twisted shielded cable 1 and another cable (another member) O.

The other cable O is, for example, a thick electric wire such as a power line or a thin electric wire such as another signal line, and includes a conductor O1 and an insulator O2 covering a periphery of the conductor O1. The two-core twisted shielded cable 1 and the other cable O are wound with a resin tape RT or are attached with a corrugated tube (not shown), a terminal (not shown), a connector (not shown), or the like.

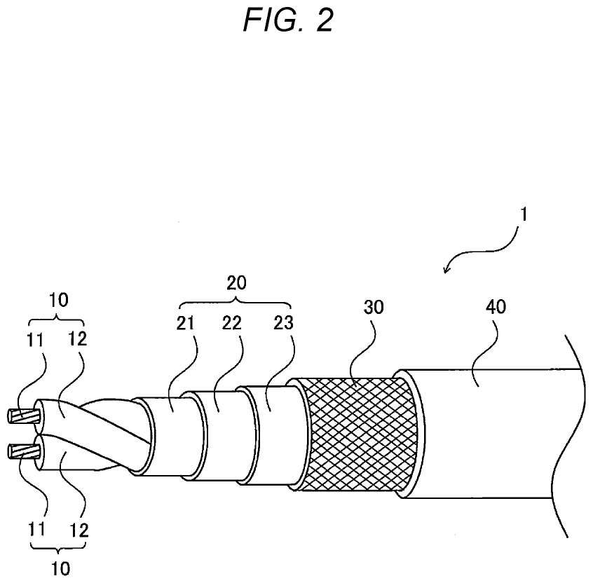

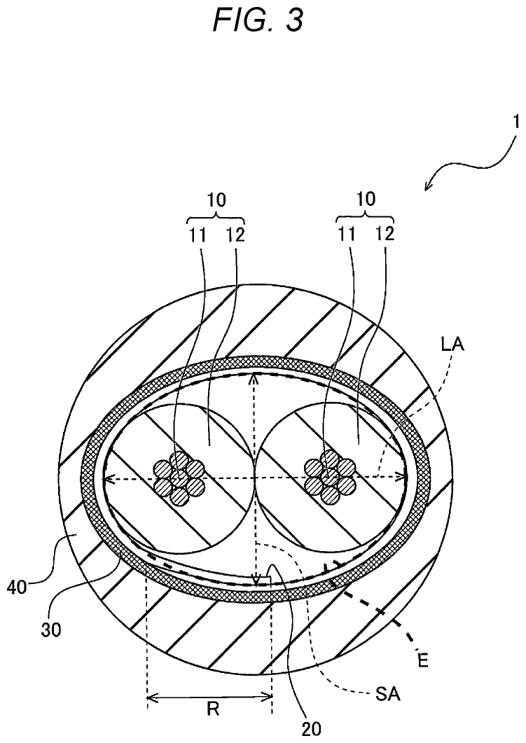

FIG. 2 is a perspective view showing the two-core twisted shielded cable 1 shown in FIG. 1, and FIG. 3 is a cross-sectional view showing the two-core twisted shielded cable 1 shown in FIG. 1. As shown in FIGS. 2 and 3, the two-core twisted shielded cable 1 includes two insulated wires 10, a metal foil shield 20, a metal braid 30, and a sheath 40.

The two insulated wires 10 each include a conductor 11 and an insulator 12 on the conductor 11, and are twisted (twisted) so as to be helical with each other. As the conductor 11, for example, a soft copper wire, a silver-plated soft copper wire, a tin-plated soft copper wire, a tin-plated copper alloy wire, or the like is used. In the present embodiment, the conductor 11 is configured by a twisted wire in which two or more (specifically, seven) strands are twisted, but is not particularly limited thereto, and may be configured by one single wire. Further, a cross-sectional area of the conductor 11 is assumed to be 0.22 sq or less, but is not particularly limited thereto.

The insulator 12 is a member covering the conductor 11, and for example, polyethylene (PE) or polypropylene (PP) is used. The insulator 12 has, for example, a dielectric constant of 3.0 or less.

The metal foil shield 20 is a shield member provided longitudinally around the two insulated wires 10. The metal foil shield 20 has a three-layer structure including a polyethylene terephthalate (PET) film layer 21, a metal layer 23, and an adhesive layer 22 located between the PET film layer 21 and the metal layer 23 and integrally bonding the PET film layer 21 and the metal layer 23.

The PET film layer 21 is a thin film member made of PET resin. The PET film layer 21 is preferably a biaxially stretched film formed by extending longitudinally and laterally at a high temperature. This is because a strength in a longitudinal direction and a lateral direction can be made strong and hard to be broken.

The metal layer 23 is a conductive metal layer and is made of a metal such as copper or aluminum. The metal foil shield 20 is longitudinally attached on the two insulated wires 10 so that the metal layer 23 is on an outer side.

The metal braid 30 is formed by weaving a plurality of bundles of metal wires such as a soft copper wire, a silver-plated soft copper wire, a tin-plated soft copper wire, and a tin-plated copper alloy wire. The metal wire may be a plated fiber in which metal plating is performed on the fiber. Further, the metal braid 30 may be woven into a flat bundle by collectively plating a plurality of metal wires.

The sheath 40 is an insulator that covers an outer periphery of the metal braid 30. The sheath 40 is filled on an outer periphery of the metal foil shield 20 and the metal braid 30. That is, the sheath 40 does not have a tube configuration having a clearance with the metal braid 30, but is provided in a so-called solid state. The sheath 40 is provided around the insulated wire 10, the metal foil shield 20, and the metal braid 30 by performing solid extrusion on the constituent including the insulated wire 10, the metal foil shield 20, and the metal braid 30. The sheath 40 is made of, for example, PE, PP, and polyvinyl chloride (PVC). The sheath 40 is not limited to the solid state, may be formed into a tube shape and have some clearance with respect to the inner metal braid 30, or any other inclusion may be separately provided in the clearance.

In the two-core twisted shielded cable 1, the metal foil shield 20 under the following conditions is longitudinally attached on the two insulated wires 10.

First, in a cross section orthogonal to the longitudinal direction shown in FIG. 3, an ellipse E circumscribing two twisted insulated wires 10 is defined. The ellipse E has a major axis LA in a direction in which the two insulated wires 10 are arranged, and a minor axis SA in a direction orthogonal to the major axis LA. The major axis LA is the sum of outer diameters of the two insulated wires 10, and the minor axis SA is 1.64 times the average outer diameter of the two insulated wires 10.

In this case, a width (length in a peripheral direction) of the metal foil shield 20 is the width=an elliptical circumference/(1−α). Here, a is 0.20≤α≤0.40. The elliptical circumference is a circumference length of the above defined ellipse E.

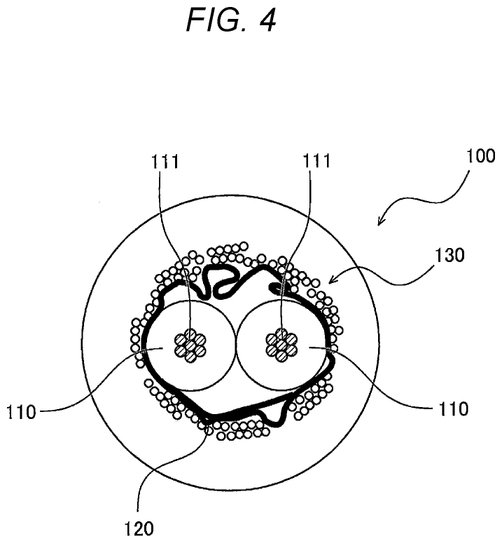

FIG. 4 is an end view showing a two-core twisted shielded cable 100 in Reference Example 1. As shown in FIG. 4, in Reference Example 1, a metal foil shield 120 is longitudinally attached around two insulated wires 110, and a metal braid 130 formed of a metal wire is provided around the metal foil shield 120. Here, in the two-core twisted shielded cable 100 according to Reference Example 1, α>0.40. Therefore, an overlapping margin R (see FIG. 3) of the metal foil shield 120 becomes too large, and a frictional force of the metal foil shield 120 becomes excessive. As a result, in the two-core twisted shielded cable 100 according to Reference Example 1, wrinkles are easily generated in the metal foil shield 120. Therefore, in Reference Example 1, a distance between the two insulated wires 110 (particularly, the conductor 111) and the metal foil shield 120 becomes unstable, and communication characteristics deteriorate.

However, the two-core twisted shielded cable 1 according to the present embodiment satisfies α≤0.40. Therefore, the overlapping margin R (see FIG. 3) of the metal foil shield 20 does not become too large, and the frictional force of the metal foil shield 20 is prevented. As a result, it is possible to prevent occurrence of wrinkles as shown in FIG. 4, and it is possible to make it difficult for the communication characteristics to deteriorate.

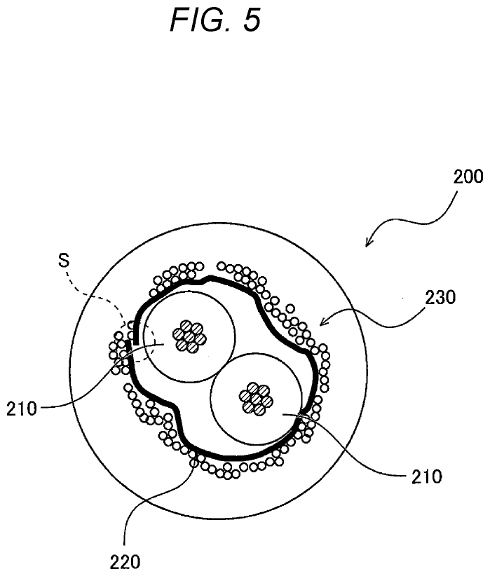

FIG. 5 is an end view showing a two-core twisted shielded cable 200 in Reference Example 2. As shown in FIG. 5, in Reference Example 2, a metal foil shield 220 is longitudinally attached around two insulated wires 210, and a metal braid 230 formed of a metal wire is provided around the metal foil shield 220. Here, the two-core twisted shielded cable 200 according to Reference Example 2 satisfies α≤0.20. Therefore, an overlapping margin R (see FIG. 3) of the metal foil shield 220 becomes too small, and a clearance S is easily generated. As a result, the noise shielding effect decreases, and the communication characteristics deteriorate.

However, in the two-core twisted shielded cable 1 according to the present embodiment, α≥0.20. Therefore, the overlapping margin R (see FIG. 3) of the metal foil shield 20 can be ensured, and the clearance S is hardly generated in the metal foil shield 20. As a result, it is possible to prevent a situation in which the noise shielding effect is normally exhibited and the communication characteristics deteriorate.

In the above description, lengths of the major axis LA and the minor axis SA are defined on the assumption that the two insulated wires 10 have different outer diameters, but when the two insulated wires 10 have the same outer diameter, the major axis LA is twice the outer diameter of one insulated wire 10, and the minor axis is 1.64 times the outer diameter.

In the present embodiment, the metal foil shield 20 has a thickness of 15 μm or more and 120 μm or less, and 0.10≤(the metal layer thickness/the PET film layer thickness)≤1.25.

Here, if the metal layer 23 becomes too thick, the metal foil shield 20 becomes too hard as a whole, and it becomes difficult to longitudinally attach the metal foil shield 20 along the two insulated wires 10.

However, since the two-core twisted shielded cable 1 according to the present embodiment has a thickness of 15 μm or more and 120 μm or less and (the metal layer thickness/the PET film layer thickness)≤1.25, the metal foil shield 20 does not become too hard, and the metal foil shield 20 is easily longitudinally attached along the two insulated wires 10. Therefore, manufacturing of products is not difficult.

When the PET film layer 21 becomes too thick, a force to open the PET film layer 21 acts after the longitudinal attachment, and wrinkles are easily generated when the metal braid 30 is provided on the outer peripheral side of the metal foil shield 20. That is, similarly to the case described with reference to FIG. 4, the distance between the two insulated wires 110 (particularly, the conductor 111) and the metal foil shield 120 becomes unstable, and the communication characteristics deteriorate.

However, since the two-core twisted shielded cable 1 according to the present embodiment has a thickness of 15 μm or more and 120 μm or less and (the metal layer thickness/the PET film layer thickness)≥0.10, the PET film layer 21 does not become too thick. As a result, a force to open the metal foil shield 20 is less likely to act after the longitudinal attachment, and it is possible to reduce occurrence of wrinkles when the metal braid 30 is provided on the outer peripheral side. Accordingly, it is possible to make it difficult for a situation in which communication characteristics deteriorate to occur.

Next, the communication characteristics of the two-core twisted shielded cables according to examples and comparative examples will be described.

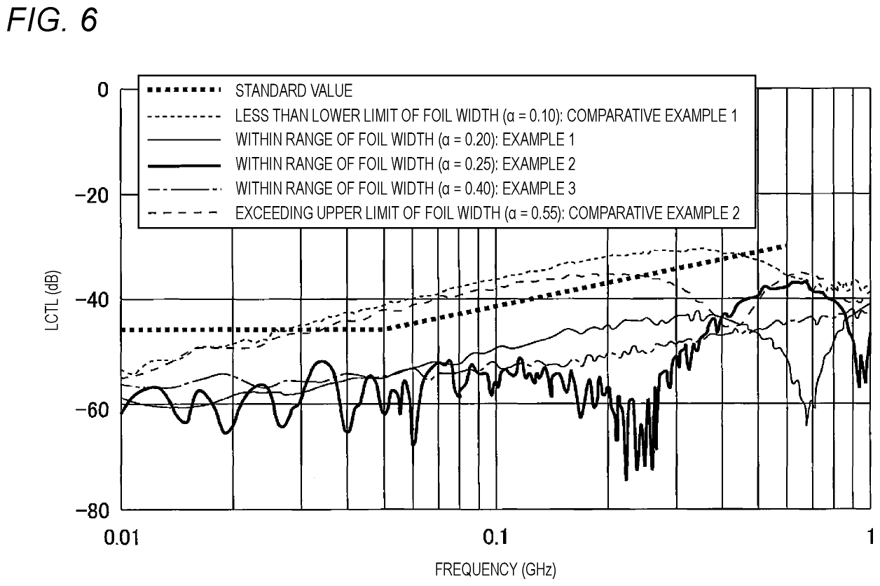

FIG. 6 is a graph showing the communication characteristics when a value of α of the width=an elliptical circumference/(1−α) is changed. First, as shown in Comparative Example 1 of FIG. 6, when the value of α was 0.10 (less than a lower limit of a range), a standard value was not satisfied in a range from about 0.028 GHz to about 0.45 GHz. In addition, as shown in Comparative Example 2, when the value of α was 0.55 (exceeding an upper limit of the range), the standard value was not satisfied in the range from about 0.035 GHz to about 0.25 GHz. As described above, it was confirmed that when the value of α was out of the range, the communication characteristics were deteriorated as described with reference to FIGS. 4 and 5.

In contrast, as shown in Examples 1 to 3, when the value of α was 0.20, 0.25, and 0.40 (within the above range), it was confirmed that the standard value was satisfied in the entire range from 0.01 GHz to 1 GHz. Accordingly, it was confirmed that the standard value is satisfied by setting 0.20≤α≤0.40 in a calculation formula of the width=the elliptical circumference/(1−α).

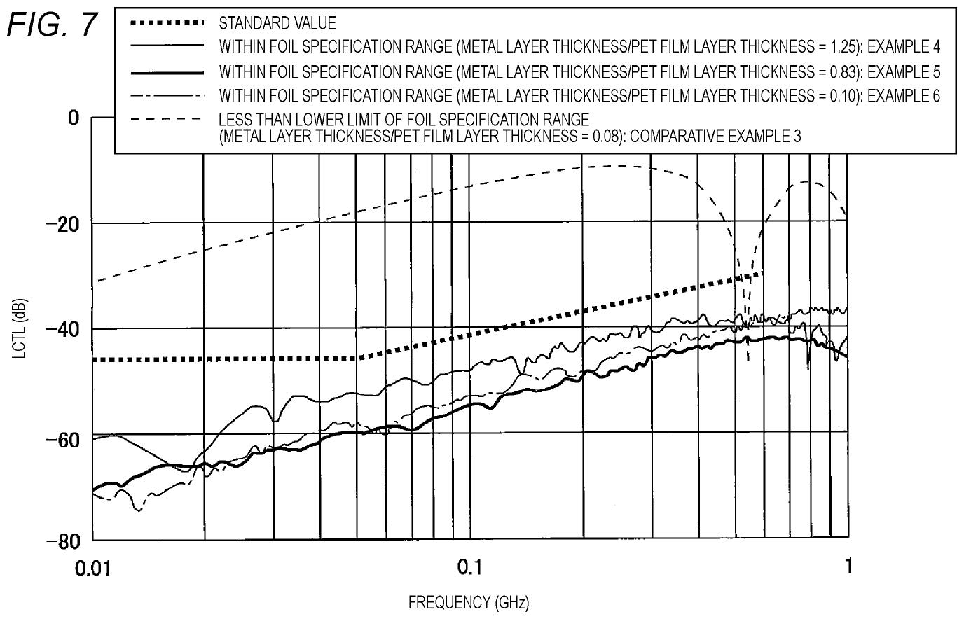

FIG. 7 is a graph showing the communication characteristics when a value of the metal layer thickness/the PET film layer thickness is changed. In FIG. 7, results (average values) of setting the thickness of the metal foil shield to various values within the range from m to 120 μm are shown.

First, as shown in Comparative Example 3 of FIG. 7, when the value of (the metal layer thickness/the PET film layer thickness) was 0.08 (less than the lower limit of the above range), the standard value was satisfied only within a part of a range from about 0.5 GHz to about 0.6 GHz. It is difficult to manufacture a two-core twisted shielded cable using a metal foil shield having a value of (the metal layer thickness/the PET film layer thickness) exceeding 1.25.

In contrast, as shown in Examples 4 to 6, when the value of (the metal layer thickness/the PET film layer thickness) was 1.25, 0.83, and 0.10 (within the above range), it was confirmed that the standard value was satisfied in the entire range from 0.01 GHz to 1 GHz. Accordingly, it was confirmed that the standard value was satisfied by setting 0.10≤(the metal layer thickness/the PET film layer thickness)≤1.25.

In this manner, according to the two-core twisted shielded cable 1 and the wire harness WH of the present embodiment, since the metal foil shield 20 is longitudinally provided around the two insulated wires 10, it is possible to contribute to preventing the manufacturing cost, and it is possible to prevent a situation in which it is difficult to trim due to a spiral lap portion.

The metal foil shield 20 has a relationship of the width=the elliptical circumference/(1−α), and 0.20≤α≤0.40. Here, since α≤0.40, the overlapping margin R of the metal foil shield 20 is not too large, so that a situation in which the frictional force of the metal foil shield 20 becomes excessive, wrinkles occur and the communication characteristics deteriorate hardly occurs. In addition, since α≥0.20, it is possible to reduce the possibility that the overlapping margin R becomes insufficient, the clearance S is generated in the metal foil shield 20, and the communication characteristics deteriorate.

Since the thickness of the metal foil shield 20 is 15 μm or more and 120 μm or less and (the metal layer thickness/the PET film layer thickness) 1.25, it is possible to prevent a situation in which the metal layer 23 becomes thick, the metal foil shield 20 becomes too hard to follow the two insulated wires 10, and the transmission characteristics become unstable. In addition, since the thickness of the metal foil shield 20 is 15 μm or more and 120 μm or less and (the metal layer thickness/the PET film layer thickness)≥0.10, it is possible to reduce the possibility that the PET film layer 21 becomes too thick, a force to open the PET film layer 21 acts after the PET film layer 21 is longitudinally attached, and wrinkles are easily generated when the metal braid 30 is provided on the outer peripheral side.

Accordingly, it is possible to provide the two-core twisted shielded cable 1 and the wire harness WH which are inexpensive, can be easily trimmed, and can prevent the deterioration of the transmission characteristics.

Although the present invention has been described above based on the embodiment, the present invention is not limited to the embodiment described above, and modifications may be made without departing from the gist of the present invention and publicly known or well-known techniques may be appropriately combined.

For example, in the embodiment described above, the metal foil shield 20 is disposed such that the metal layer 23 faces outward in the two-core twisted shielded cable 1, but the present invention is not limited thereto, and the metal layer 23 may face inward.

Although it is assumed that the metal braid 30 is attached to a shield connector in the two-core twisted shielded cable 1 according to the embodiment, a target to be attached may not be the shielded connector.

What is claimed is:

1. A two-core twisted shielded cable comprising:
two insulated wires each including a conductor and an insulator covering the conductor, the two insulated wires being twisted together;
a metal foil shield provided longitudinally around the two insulated wires;
a metal braid provided on an outer periphery of the metal foil shield; and
a sheath provided on an outer periphery of the metal braid,
wherein a width of the metal foil shield satisfy a following relationship,
the width=an elliptical circumference/(1−α), and 0.20≤α≤0.40,
wherein the elliptical circumference is a circumference length of an ellipse circumscribing the two insulated wires twisted together in a cross section orthogonal to a longitudinal direction,
wherein a first direction in which the two insulated wires are arranged is defined as a major axis,
wherein a second direction orthogonal to the major axis is defined as a minor axis,
wherein the major axis is the sum of outer diameters of the two insulated wires,
wherein the minor axis is 1.64 times the average outer diameter of the two insulated wires,
wherein the ellipse has the major axis and the minor axis, and
wherein the metal foil shield has a thickness of 15 μm or more and 120 μm or less,
includes a metal layer and a PET film layer, and 0.10≤(a metal layer thickness/a PET film layer thickness)≤1.25.

2. A wire harness comprising:
the two-core twisted shielded cable according to claim 1; and
another member adjacent to the two-core twisted shielded cable.
